(19) United States
(12) Patent Application Publication
(10) Pub. No.: US 2005/0288053 A1
(43) Pub. Date: Dec. 29, 2005

(54) Transmission power control

(76) Inventor: Jian Gu, Guandong (CN)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/928,697

(22) Filed: Aug. 30, 2004

(30) Foreign Application Priority Data
Jun. 28, 2004 (FI) 20045244

(51) Int. Cl. H04Q 7/20

(52) U.S. Cl. 455/522; 455/69

(57) ABSTRACT

At least two transceivers of the radio system communicate using a packet switched connection over a radio interface. The quality of at least one packet having failure in reception is estimated and the transmission power of a retransmission is controlled according to the quality of the at least one packet having failure in reception. A receiver transmits a request to retransmit at least one packet having failure in reception during communication. A transmitter retransmits at least one packet requested as a response to the request using the controlled power.

### FIELD

The invention relates to a transmission power control in a connection of a radio system.

### BACKGROUND

It is vital to have power control of signals in a radio system. This is of particular importance in a CDMA (Code Division Multiple Access) radio system, which is interference-limited. The main task of the power control in a CDMA radio system is to set signal powers to the desired level, and hence increase capacity by decreasing interference.

For example, in a WCDMA (Wide band CDMA) radio system the power control mechanism comprises an inner loop power control and an outer loop power control.

The purpose of the inner loop power control is to eliminate rapid variations in the strength of a received signal caused by the radio channel and propagation.

In the uplink inner loop power control, a base station compares the measured SIR (Signal Interference Ratio) of the received signal to a target SIR. If the measured SIR of the received signal is below the target SIR, the base station transmits a signal commanding the user terminal to increase its transmission power. Correspondingly, if the SIR of the received signal is above the target SIR, the base station transmits a signal commanding the user terminal to decrease its transmission power.

In the uplink outer loop control, a radio network controller (RNC) compares the quality of service to a target quality. The quality can be measured as, for instance, BER (Bit Error Rate), BLER (Block Error Rate), FER (Frame Error Rate), CRC (Cyclic Redundancy Check), soft information from the decoder, ratio of received bit energy and noise, etc. If the quality of service is below the target quality, the RNC commands the base station to increase its target SIR. Similarly, if the quality of service is above the target quality, the RNC commands the base station to decrease its target SIR.

In radio systems utilizing a packet-switched connection, the packets are usually protected against noise, fading and interference by channel coding, such as FEC (Forward Error correction Coding). In spite of protection, failure may occur in the reception of a packet, which can be compensated for by retransmission. The retransmission takes place when the receiving transceiver of packets requests the faulty packet to be repeated. This can be performed by an ARQ (Automatic Repeat Request) mechanism. In a receiver utilizing HARQ (Hybrid ARQ), the faulty packet and the retransmitted packet can be combined. The combining can be especially effective if different transmissions of the same packet are utilized in decoding.

There are, however, problems related to the use of retransmission with power control, especially in the case of HARQ. When a packet is communicated unsuccessfully, the outer loop power control increases the target SIR, which unnecessarily leads to a higher transmission power during retransmission of the packet. The increased transmission power increases interference and decreases the capacity and service quality of the radio system.

The outer loop control can also set the retransmission target SIR a predetermined amount lower than the target SIR of the first transmission of a packet. The transmission power of a retransmission may become too low and unnecessary many retransmissions may be performed which impairs the throughput and increase interference. Additionally, these problems tend to increase as the number of users per one cell grows.

### BRIEF DESCRIPTION OF THE INVENTION

An object of the invention is to provide an improved method, a network infrastructure, a radio system, a base station, a radio network controller, a computer program product.

According to an aspect of the invention, there is provided a method of controlling transmission power in a radio system using a transmission power control, the method comprising: communicating between at least two transceivers of the radio system using a connection over a radio interface; transmitting, from a transceiver receiving packets during communication, a request to retransmit at least one packet having failure in reception; retransmitting, from a transceiver transmitting packets, at least one packet requested as a response to the request. The method further comprises estimating the quality of at least one packet having failure in reception; and controlling the transmission power of a retransmission according to the estimated quality of the at least one packet having failure in reception.

According to another aspect of the invention, there is provided a method of controlling transmission power in a radio system using a transmission power control, the method comprising: communicating between a network infrastructure and at least one user terminal of the radio system using a connection over a radio interface; transmitting, from the at least one user terminal receiving packets during communication, a request to retransmit at least one packet having failure in reception; retransmitting, from the network infrastructure transmitting packets, at least one packet requested as a response to the request. The method further comprises estimating the quality of at least one packet having failure in reception; and controlling the transmission power of a retransmission according to the estimated quality of the at least one packet having failure in reception.

According to another aspect of the invention, there is provided a network infrastructure in a radio system using a transmission power control, wherein at least one user terminal and the network infrastructure are configured to communicate using a connection over a radio interface, the at least one user terminal receiving packets during communication is configured to transmit a request of retransmission of at least one packet having failure in reception, and the network infrastructure transmitting packets is configured to retransmit at least one packet requested as a response to the request. The network infrastructure further comprises an estimator configured to estimate the quality of at least one packet having failure in reception; and a controller configured to control the transmission power of a retransmission according to the estimated quality of the at least one packet having failure in reception.

According to another aspect of the invention, there is provided a network infrastructure in a radio system using a transmission power control, wherein at least one user terminal and the network infrastructure are configured to communicate using a CDMA connection over a radio interface, the at least one user terminal receiving packets during communication is configured to transmit a request of retransmission of at least one packet having failure in reception, and the network infrastructure transmitting packets is configured to retransmit at least one packet requested as a response to the request. The network infrastructure further comprises means for estimating the quality of at least one packet having failure in reception; and means for controlling the transmission power of a retransmission according to the estimated quality of the at least one packet having failure in reception.

According to another aspect of the invention, there is provided a radio system using a transmission power control, wherein at least two transceivers are configured to communicate using a connection over a radio interface, the at least one transceiver receiving packets during communication is configured to transmit a request of retransmission of at least one packet having failure in reception, and the at least one transceiver transmitting packets is configured to retransmit at least one packet requested as a response to the request. The radio system further comprises an estimator configured to estimate the quality of at least one packet having failure in reception; and a controller configured to control the transmission power of a retransmission according to the estimated quality of the at least one packet having failure in reception.

According to another aspect of the invention, there is provided a radio system using a transmission power control, wherein at least one user terminal and the network infrastructure are configured to communicate using a connection over a radio interface, the at least one user terminal receiving packets during communication is configured to transmit a request of retransmission of at least one packet having failure in reception, and the network infrastructure transmitting packets is configured to retransmit at least one packet requested as a response to the request. The radio system further comprises an estimator configured to estimate the quality of at least one packet having failure in reception; and a controller configured to control the transmission power of a retransmission according to the estimated quality of the at least one packet having failure in reception.

According to another aspect of the invention, there is provided a base station in a radio system using a transmission power control, wherein at least one user terminal and the network infrastructure are configured to communicate using a connection over a radio interface, the at least one user terminal receiving packets during communication is configured to transmit a request of retransmission of at least one packet having failure in reception, and the network infrastructure transmitting packets is configured to retransmit at least one packet requested as a response to the request. The network infrastructure further comprises means for estimating the quality of at least one packet having failure in reception; and means for controlling the transmission power of a retransmission according to the estimated quality of the at least one packet having failure in reception.

According to another aspect of the invention, there is provided a radio network controller in a radio system using a transmission power control, wherein at least one user terminal and the network infrastructure are configured to communicate using a connection over a radio interface, the at least one user terminal receiving packets during communication is configured to transmit a request of retransmission of at least one packet having failure in reception, and the network infrastructure transmitting packets is configured to retransmit at least one packet requested as a response to the request. The network infrastructure further comprises means for estimating the quality of at least one packet having failure in reception; and means for controlling the transmission power of a retransmission according to the estimated quality of the at least one packet having failure in reception.

According to another aspect of the invention, there is provided a computer program product encoding a computer process for controlling transmission power in a radio, wherein at least one user terminal and the network infrastructure are configured to communicate using a connection over a radio interface, the at least one user terminal receiving packets during communication is configured to transmit a request of retransmission of at least one packet having failure in reception, and the infrastructure transmitting packets is configured to retransmit at least one packet requested as a response to the request. The process further comprises: estimating the quality of at least one packet having failure in reception; and controlling the transmission power of a retransmission according to the estimated quality of the at least one packet having failure in reception.

The invention provides several advantages. The transmission power in retransmission can be adjusted as a function of the quality of an unsuccessful signal or a portion of signal. This decreases interference and increases throughput while guaranteeing the quality of connection.

### LIST OF DRAWINGS

In the following, the invention will be described in greater detail with reference to the embodiments and the accompanying drawings, in which

FIG. 1 shows a radio system;

FIG. 2 illustrates outer and inner loop power control,

FIG. 3 illustrates a flow chart of the method,

FIG. 4 illustrates the procedure of transmission and retransmission, and

FIG. 5 illustrates a closed loop power control.

### DESCRIPTION OF EMBODIMENTS

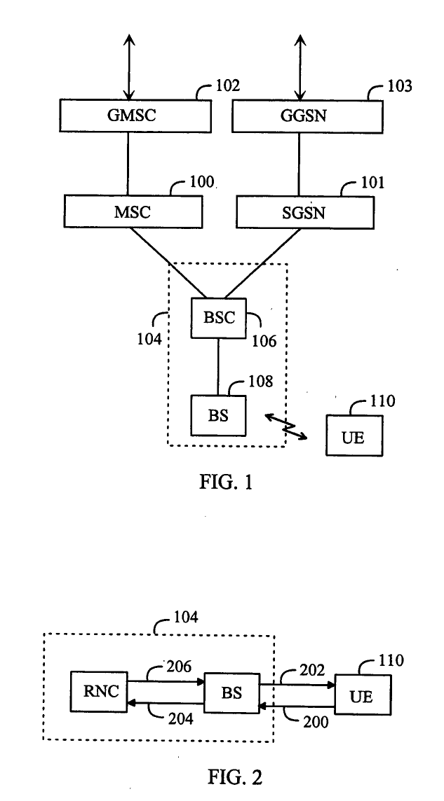

Let us first study FIG. 1 that illustrates the structure of a radio system. The radio system can be based on, for example, UMTS (Universal Mobile Telephone System) or WCDMA (Wide-band Code Division Multiple Access).

The core network may, for example, correspond to the combined structure of the GSM (Global System for Mobile Communications) and GPRS (General Packet Radio Service) systems. The GSM network elements are responsible for the implementation of circuit-switched connections, and the GPRS network elements for the implementation of packet-switched connections, some of the network elements being, however, shared by both systems.

A mobile services switching centre (MSC) 100 enables circuit-switched signalling in the radio system. A serving GPRS support node (SGSN) 101 in turn enables packet-switched signalling. All traffic in the radio system may be controlled by the MSC 100.

The core network may have a gateway unit 102, which represents a gateway mobile service switching centre (GMSC) for attending to the circuit-switched connections between the core network and external networks, such as a public land mobile network (PLMN) or a public switched telephone network (PSTN). A gateway GPRS support node (GGSN) 103 attends to the packet-switched connections between the core network and external networks, such as the Internet.

The MSC 100 and the SGSN are connected to a network infrastructure 104, such as radio access network (RAN). The network infrastructure 104 may be a unique unit or it may include at least one base station controller 106 controlling at least one base station 108. The base station controller 106 can also be called a radio network controller, and the base station can be called a node B. A user terminal 110 communicates with at least one base station 108 over a radio interface.

The user terminal 110 can communicate with the base station 108 over air interface. Data in packets contain address and control data in addition to the actual traffic data. Several connections may employ the same transmission channel simultaneously. A packet-switching method is suitable for data transmission where the data to be transmitted is generated in bursts. In such a case, it is not necessary to allocate a data link for the entire duration of transmission but only for the time it takes to transmit the packets. This reduces costs and saves capacity considerably during both the set-up and the use of the network.

FIG. 2 represents both outer and inner loop power control. When the user terminal 110 transmits a signal 200, such as a packet, to a network infrastructure 104, such as a base station, the network infrastructure 104 forms a SIR (Signal-to-Interference Ratio) estimate of the received signal. The network infrastructure 104 compares the SIR estimate to a target SIR, and transmits a signal 202 with a command, which depends on the comparison. If the value of the SIR estimate is smaller than the value of the target SIR, the network infrastructure 104 commands the user terminal 110 to increase its transmission power. If, on the other hand, the SIR estimate is higher than the target SIR, the network infrastructure 104 commands the user terminal to decrease its transmission power.

A CRC (Cyclic Redundancy Check) can be performed in a base station to check if a packet (or a frame) is correctly received or has a failure in reception. In the case of a successful reception of a packet, the network infrastructure 104 (base station or radio network controller) may measure the quality of the received signal. That may take place such that the base station measures the quality of the received signal and sends the radio network controller 106 a signal 204 having information on the quality. The quality can be measured as the quality of service and it can be indicated by, for instance, frame reliability using CRC (Cyclic Redundancy Check), BER, FER, soft information from a decoder, E_{b}/N₀, etc.

The target SIR_{1target} of the first transmission can be adjusted by an outer-loop power control algorithm, which in prior art can be expressed as follows: SIR_{1target}(n+1)=SIR_{1target}(n)±Δ_{PC}[dB], where n is an index of the iteration and Δ_{PC}[dB] is the size of the step to increase or decrease the transmission power in decibels. The increase and the decrease of the transmission power can be performed using separate steps and the power may have an upper limit and a lower limit. Hence, the power control can be expressed more accurately, for example, as:
SIR_{1target}(n+1)=min{SIR_{1target}(n)+Δ_{PC}_{_{—}}_{UP}[dB],SIR₁ₘₐₓ}, (1)
SIR_{1target}(n+1)=max{SIR_{1target}(n)−Δ_{PC}_{_{—}}_{DOWN}[dB],SIR₁ₘᵢₙ}, (2)
where min{x, y} means the minimum value among the elements x and y, n is an index of the iteration, Δ_{PC}_{_{—}}_{UP}[dB] is the size of the step to increase the transmission power, Δ_{PC}_{_{—}}_{DOWN}[dB] is the size of the step to decrease the transmission power, SIR₁ₘₐₓ is the maximum SIR of the first transmission, SIR₁ₘᵢₙ is the minimum SIR of the first transmission, and the subscript 1 refers to the first transmission of a packet. The step size of the Δ_{PC}_{_{—}}_{DOWN} can be calculated as follows:

$${Δ}_{PC\_DOWN} = \frac{{Δ }_{PC\_UP}}{( 1 / {FER}_{1 target} ) - 1} \qquad ( 3 )$$

The desired FER_{1target} of the first transmission varies typically between 10% and 50%, and the step size of the Δ_{PC}_{_{—}}_{UP} may be 0.5 dB, 1 dB or 2 dB.

The network infrastructure 104 in turn may change the target SIR according to formula (1) or (2). This can take place such that the radio network controller 106 sends the base station a signal 206 having an effect on the target SIR. If the value of the quality of service is below the quality target value, which may be true in the case of failure in reception of a packet, the network infrastructure may increase the target SIR in the base station. As a result of this, the average transmission power of a retransmission of a packet in prior art may be higher than during the initial transmission of the packet. If the value of the quality of service is above a target value, the network infrastructure may decrease the target SIR in the base station, which lowers the average transmission power with respect to interference. This may take place when a packet is received successfully.

The base station 108 checks whether the reception of packets is successful by decoding the packet. If the reception is successful, i.e. the decoding succeeds, the base station 108 continues receiving packets from the subscriber terminal 110 without retransmissions. If, on the other hand, the reception fails, i.e. the decoding does not succeed, the base station 108 transmits a request to retransmit at least one packet having failure in reception. Additionally, according to the present solution the network infrastructure 104 estimates the quality of each packet having failure in reception. The quality can be estimated as a frame error rate FERₑₛₜ^{failure}, for example, as follows:

$${FER}_{est}^{failure} = 1 - {\prod }_{i = 1}^{N} \frac{1}{1 + exp [ ( 1 - 2 \cdot {u}_{i} ) \cdot {λ}_{i} ]} \qquad ( 4 )$$

where Π represents multiplication of the elements in the product, i is the index of the elements, N is the number of symbols, u represents hard decisions of symbols in a packet (or in a frame), λ represents soft decisions of the symbols output by the decoder, and exp is the natural exponential function the base of which is the Neper number e (e≈2.71828). The elements

$$\frac{1}{1 + exp [ ( 1 - 2 \cdot {u}_{i} ) \cdot {λ}_{i} ]}$$

represent probability of a received symbol and each symbol can be expressed as a bit or as a combination of bits. It should be obvious to a person skilled in the art that other approaches of estimating the frame error rate can also be utilized.

If the estimated frame error rate FERₑₛₜ^{failure} of a packet with a decoding failure has a higher value than the target frame error rate FER_{target} (FERₑₛₜ^{failure}>FER_{target}), i.e. the estimated quality is worse than a target quality, the network infrastructure 104 may control the value of the target SIR according to the quality of the packet having failure by forming a new target SIR (SIR_{rtarget}) for the retransmission of the received packet, for example, as follows:

$${SIR}_{rtarget , J + 1} = min \{ max \{ 10 \cdot {log}_{10} \{ [ {( \begin{matrix}{FER}_{est}^{failure} \\ {FER}_{target}\end{matrix} )}^{\frac{1}{t}} - 1 ] \cdot {\sum }_{j = 1}^{J} {10}^{\frac{{SIR}_{rtarget , j}}{10}} \} , {SIR}_{r\_min} \} {SIR}_{r\_max} \} \qquad ( 5 )$$

where j stands for the retransmission index of a packet, J is the number of HARQ transmissions of a packet, SIR_{rtarget,j} is the target SIR for the j^{th} retransmission, the subscript target means transmission target, SIRᵣ_{_{—}}ₘᵢₙ stands for the minimum value of the retransmission signal-to-noise ratio, SIRᵣ_{_{—}}ₘₐₓ stands for the maximum value of the retransmission signal-to-noise ratio and t is a parameter modifying the effect of the quality measured as FERₑₛₜ^{failure} on the retransmission target SIR.

If the estimated quality is better than a target quality, the transmission power in retransmission can be controlled by setting the retransmission target SIR at its minimum value (SIR_{rtarget}=SIRₘᵢₙ).

If the decoding of a packet is in error after all retransmissions, the value of the parameter t can be updated in the network infrastructure 104 as follows:
t(n+1)=max(t(n)−Δₛₗₒₚₑ_{_{—}}_{down},tₘᵢₙ) (6)
If the decoding of a packet is correct, the parameter t may be updated as follows:
t(n+1)=min(t(n)+Δₛₗₒₚₑ_{_{—}}ᵤₚ,tₘₐₓ) (7)
where n is a TTI (Transmission Timing Interval) index, tₘᵢₙ is the minimum value of the parameter, tₘₐₓ is the maximum value of the parameter. The parameter Δₛₗₒₚₑ_{_{—}}ᵤₚ can be determined in the network infrastructure 104 as:

$${Δ}_{slope\_up} = \frac{{Δ}_{slope\_down}}{( 1 / {FER}_{target} ) - 1} \qquad ( 8 )$$

The range of the parameter Δₛₗₒₚₑ_{_{—}}_{down} can be, for example, from 0.1 dB to 1 dB without being restricted to the this range. To generalize the equation (8), the value of Δₛₗₒₚₑ_{_{—}}ᵤₚ increases with the decreasing target value of the frame error rate FER_{target} and the value of Δₛₗₒₚₑ_{_{—}}ᵤₚ decreases with the increasing target value of the frame error rate FER_{target}. The frame error rate FER_{target} can be a target residual frame error rate.

The SIR target and hence the transmission power in retransmission can be controlled by controlling the effect of the quality of the at least one packet having failure in reception on the SIR target. As shown in equations (6), (7) and (8), the effect can be adapted according to a success or a failure in reception by iterating the parameter t of equation (5). The adaptation may be used to weaken the effect of the estimated quality on the retransmission target SIR if a transmission or a retransmission succeeds as expressed in equation (7). In this way, the change in a value of a retransmission target SIR with respect to the estimated quality may decrease. The adaptation may also be used to strengthen the effect of the estimated quality on the retransmission target SIR if the last retransmission has a failure in reception as expressed in equation (6). In this way, the change in a value of a retransmission target SIR with respect to the estimated quality may increase.

The iteration of the parameter t in equations (6) and (7) enables the SIR target to be adapted with variations relating to data rates, environment and imperfections in the inner loop power control.

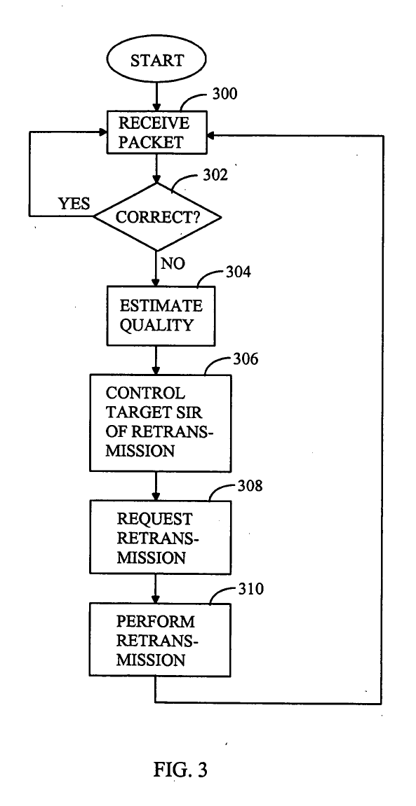

FIG. 3 illustrates a simple flow chart of the present solution. In step 300, at least two transceivers of the radio system communicate using a connection over a radio interface and the receiving transceiver receives a packet or packets. In step 302, the receiving party checks whether the reception is successful. A user terminal may represent the transmitting party and the network infrastructure may represent the receiving party. If the reception is successful, the receiving party continues to receive first transmissions of following packets in step 300. If, on the other hand, the reception is unsuccessful, the receiving party estimates the quality of at least one packet having failure in reception in step 304. In step 306, the receiving party adjusts the target SIR of the retransmission of the received packet as a function of the estimated quality. In step 308, the receiving party transmits a request to retransmit packet(s) having failure in reception. In step 310, the retransmission is carried out using a transmission power according to the adjusted SIR.

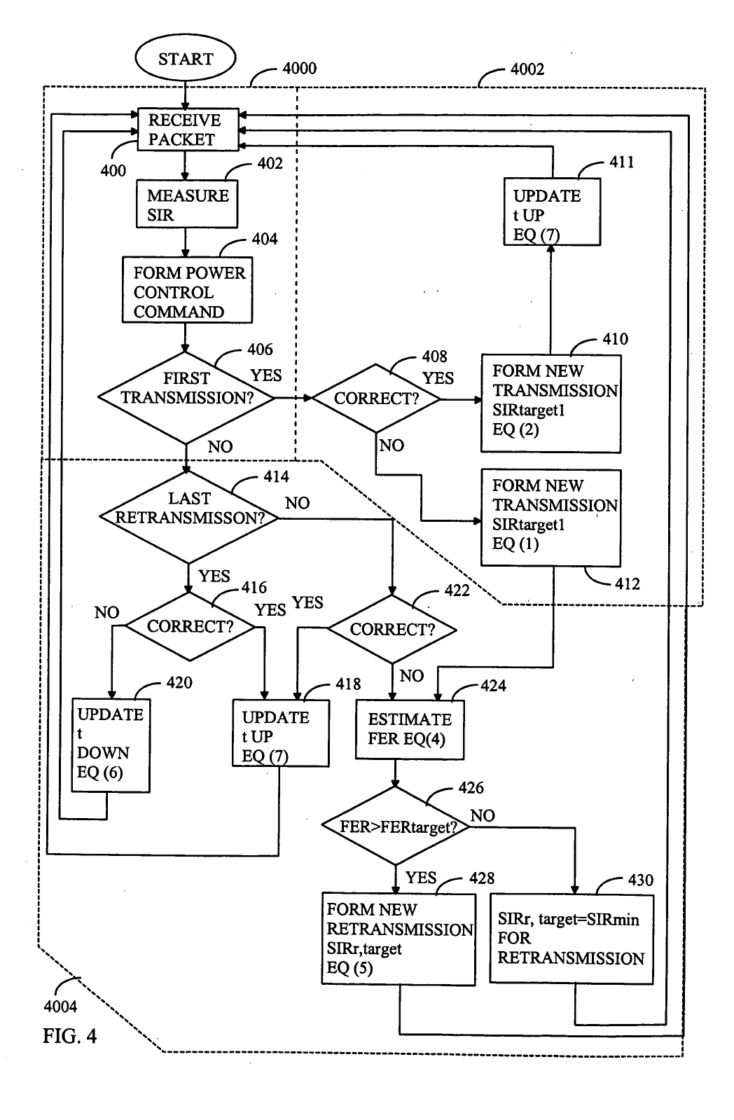

In FIG. 4, the procedure of transmission and retransmission is illustrated in more details. The steps shown in the block 4000 describe the inner loop power control. The steps shown in the block 4002 describe the outer loop power control for the first transmission and the steps shown in the block 4004 additionally describe the outer loop power control for the retransmission. In step 400, a packet is transmitted from a transmitter and received at the receiving transceiver. In step 402, the signal-to-noise ratio of the received signal is measured. In step 404, a power control command is formed based on a comparison of the measured SIR and the target SIR. In step 406, it is checked whether the received packet was transmitted for the first time or whether the packet was retransmitted. If it is a question of a first transmission, it is checked whether the packet is correctly received or whether the packet has failure in reception in step 408. If the packet is correctly received, a new target SIR is formed in the radio network controller according to equation (2) in step 410, the parameter t is updated according to equation (7) in step 411. The transmission and the reception continue in step 400. If there is a failure in reception, a new target SIR for the first transmission of the next packet is formed according to equation (1) in step 412. Additionally, the SIR target of the retransmission of the faulty packet is controlled in steps 414 to 430.

After step 406, if the transmission of the received packet is not the first transmission, it is checked whether it is a question of the last retransmission of a faulty packet in step 414.

If it is a question of a last retransmission in step 414, it is checked, whether the packet is correctly received in step 416. If the packet is properly received, the parameter t is updated according to equation (7) in step 418 and the transmission and the reception continue in step 400.

If it is a question of a last retransmission in step 414, and the packet has failure in reception when checked in step 416, the parameter t is updated according to equation (6) in step 420. The transmission and the reception continue in step 400.

If it is not a question of the last retransmission in step 414, it is checked whether the packet has failure in reception or not in step 422. If the packet is properly received, the parameter t is updated according to equation (7). The transmission and the reception continue in step 400.

If it is not a question of the last retransmission in step 414, and the packet has failure in reception when checked in step 422, a frame error rate relating to the packet is estimated in step 424 according to equation (4). In step 426, the estimated frame error rate FERₑₛₜ^{failure} is compared with the target frame error rate FER_{target}, and if the estimated frame error rate FERₑₛₜ^{failure} has a higher value than the target frame error rate FER_{target}, a new target SIR for retransmission is formed according to equation (5) in step 428. The transmission, the retransmission and the reception continue using a new retransmission target SIR in step 400. If the estimated frame error rate FERₑₛₜ^{failure} has a lower value than the target frame error rate FER_{target}, a new target SIR for retransmission is formed by setting the minimum value for the target SIR in step 430. The transmission, the retransmission and the reception continue in step 400.

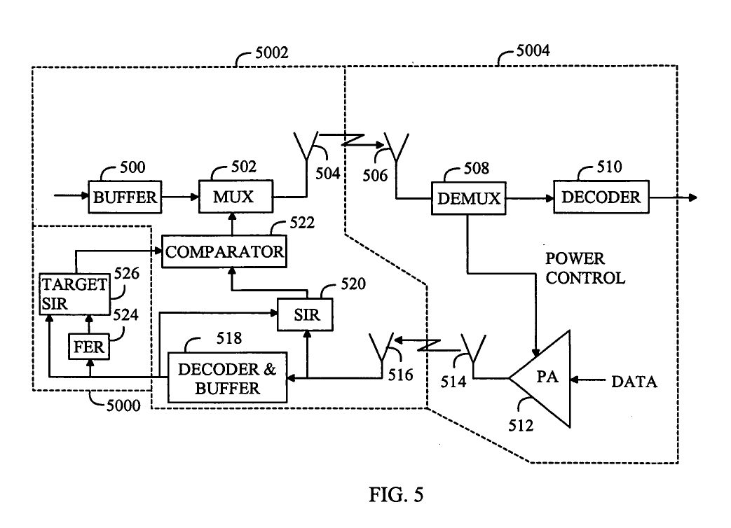

FIG. 5 illustrates a closed loop power control. The data for the user can be fed from a buffer memory 500 to a multiplexer 502, which multi-plexes the power control bits to the data stream in a base station 108. The buffer memory is not always needed. The data is encoded by a FEC code, such as a turbo code, and the data may also include information on the type of HARQ (for example type I HARQ, type II HARQ, type III HARQ). The baseband signal with data and power control bits is mixed with a desired carrier frequency after certain signal processing, such as spread spectrum or OFDM (coding, type defining, mixing and other signal processing are not shown in FIG. 5) in order to transmit the radio frequency signal from the antenna 504. The antenna 504 can comprise a single antenna or a plurality of antennas. The antenna 506 of a user terminal 110 receives the signal. The antenna can comprise a single antenna or a plurality of antennas. The signal is mixed to a baseband signal (mixing and other signal processing are not shown in FIG. 5). The signal is demultiplexed in a demultiplexer 508, which separates data and power control bits. The data is fed to a decoder 510 to be decoded. The power control bits are fed to a power amplifier 512, which adjusts its amplification according to the power control bits. The power amplifier 512 amplifies the signal to be transmitted by the user terminal 110. The transmitter of the user terminal is basically similar to the transmitter of the base station. The signal is transmitted from the antenna 514, which may be the same as the antenna 506. The antenna 516, which may be the same as the antenna 504, receives the signal, which is mixed to a baseband signal (mixing is not shown in FIG. 5). The signal is then fed to a decoder 518. The decoder 518 decodes packets and checks whether a packet is correctly received or whether a packet has a failure in reception. The decoder 518 may include a buffer memory for storing a packet. If a packet is determined faulty, the packet may be stored in the buffer memory and a retransmission is requested. The SIR measurement in a measuring unit 520 can be made before or after the decoding (either of the two arrows). The measuring unit 520 performs the SIR estimation on the received signal. Generally, the SIR measurement is divided into a signal power measurement and an interference power measurement. The measurement can be performed on, for example, the DPCCH channel (Dedicated Physical Control Channel). The quality of service is measured in a measuring unit 524, for example, as a frame error rate of the decoded signal according to equation (4). The retransmission target SIR is formed in a target unit 526 according to equation (5) or the retransmission target SIR is set as minimum. The target unit 526 may also form the target SIR of the first transmission. The measured SIR is compared with the target SIR in a comparator 522. On the basis of the comparison, the comparator 522 feeds the power control bits to the multiplexer 502. For uplink outer loop power control the block 5002 may reside in a base station whereas the block 5000 may reside in the radio network controller or a base station and the block 5004 may reside in user terminals. For downlink outer power control, the blocks 5000 and 5002 may reside in user terminals whereas the block 5004 may reside in a base station.

Chase combining where a retransmitted packet is similar to the originally transmitted packet can be used to implement HARQ. To further improve performance, it is also possible to use incremental redundancy (IR), where a retransmitted packet comprises new redundancy bits. To utilize HARQ, the receiving transceiver can be equipped with a buffer memory in which faulty packets can be stored (in FIG. 5 the block 510 includes the buffer memory). The transmitter may also have a memory (in FIG. 5 the block 500) to be able to retransmit the at least one packet requested.

Method steps of the power control can be implemented as software run in a microprocessor. A partial equipment implementation alone or with the software can also be applied, especially using ASIC (Application Specific Integrated Circuit). Hence, a computer program product encoding a computer process for controlling transmission power can be provided, the process implementing the method. The computer program product may be embodied on a computer program distribution medium. The computer program distribution medium may include known ways in the art for distributing software, such as a computer readable medium, a program storage medium, a record medium, a computer readable memory, a computer readable software distribution package, a computer readable signal, a computer readable telecommunication signal, and a computer readable compressed software package.

Even though the invention is described above with reference to examples according to the accompanying drawings, it is clear that the invention is not restricted thereto but can be modified in several ways within the scope of the appended claims.

1. A method of controlling transmission power in a radio system using a transmission power control, the method comprising:
communicating between at least two transceivers of a radio system using a connection over a radio interface;
transmitting, from a transceiver receiving packets during communication, a request to retransmit at least one packet having failure in reception;
retransmitting, from a transceiver transmitting packets, at least one packet requested as a response to the request;
estimating quality of the at least one packet having failure in reception; and
controlling transmission power of a retransmission according to the quality of the at least one packet having failure in reception.

2. A method of controlling transmission power in a radio system using a transmission power control, the method comprising:
communicating between a network infrastructure and at least one user terminal of a radio system using a connection over a radio interface;
transmitting, from the at least one user terminal, a request to retransmit at least one packet having failure in reception;
retransmitting, from the network infrastructure, at least one packet requested as a response to the request;
estimating quality of the at least one packet having failure in reception; and
controlling transmission power of a retransmission according to the quality of the at least one packet having failure in reception.

3. The method of claim 1, further comprising:
controlling the transmission power of the retransmission by adjusting a retransmission target Signal Interference Ratio (SIR) according to the quality of the at least one packet having failure in reception if the quality is worse than a target quality.

4. The method of claim 3, further comprising:
controlling the transmission power of the retransmission by setting the retransmission target Signal Interference Ratio (SIR) at a minimum value if the quality is better than a target quality.

5. The method of claim 3, further comprising:
controlling the transmission power of the retransmission according to an effect of the quality of the at least one packet having failure in reception on the retransmission target Signal Interference Ratio (SIR); and
adapting the effect according to at least one of success and failure of the at least one packet in reception.

6. The method of claim 5, further comprising:
weakening quality of at least one faulty packet if a retransmission succeeds.

7. The method of claim 5, further comprising:
strengthening the effect of quality of at least one faulty packet on the retransmission target Signal Interference Ratio (SIR) if a last retransmission has a failure in reception.

8. The method of claim 2, further comprising:
estimating the quality of the at least one packet having failure in reception as follows:
$${FER}_{est}^{failure} = 1 - {\prod }_{i = 1}^{N} \frac{1}{1 + exp [ ( 1 - 2 \cdot {u}_{i} ) \cdot {λ}_{i} ]} ,$$
where the quality is estimated using frame error rate FERₑₛₜ^{failure}, Π represents multiplication of elements in a product, i is an index of the elements, N is a number of symbols, u represents hard decisions of symbols received, λ represents soft decisions of the symbols received, and exp is a natural exponential function.

9. The method of claim 2, further comprising:
controlling the transmission power of the retransmission by adjusting a retransmission target Signal Interference Ratio (SIR) as follows:
$${SIR}_{rtarget , J + 1} = min \{ max \{ 10 \cdot {log}_{10} \{ [ {( \frac{{FER}_{est}^{failure}}{{FER}_{target}} )}^{\frac{1}{t}} - 1 ] \cdot {\sum }_{j = 1}^{J} {10}^{\frac{{SIR}_{rtarget , j}}{10}} \} , {SIR}_{r\_min} \} {SIR}_{r\_max} \} ,$$
where j stands for a retransmission index of a packet, J is a number of Hybrid Automatic Repeat Request (HARQ) transmissions of a packet, SIR_{r-target,j} is a target SIR for a j^{th} retransmission, a subscript target means transmission target, SIRᵣ_{_{—}}ₘᵢₙ stands for a minimum value of a retransmission signal-to-noise ratio, SIRᵣ_{_{—}}ₘₐₓ stands for a maximum value of the retransmission signal-to-noise ratio, and t is a parameter modifying an effect of the quality measured as FERₑₛₜ^{failure} to the retransmission target SIR.

10. The method of claim 9, further comprising:
updating the parameter t as follows:
t(n+1)=max(t(n)−Δₛₗₒₚₑ_{_{—}}_{down},tₘᵢₙ), if the reception is in failure, otherwise
t(n+1)=min(t(n)+Δₛₗₒₚₑ_{_{—}}ᵤₚ,tₘₐₓ),
where n is an iteration index, tₘᵢₙ is a minimum value of the parameter, tₘₐₓ is a maximum value of the parameter; and
forming parameter Δₛₗₒₚₑ_{_{—}}ᵤₚ as follows:
$${Δ}_{slope\_up} = \frac{{Δ}_{slope\_down}}{( 1 / {FER}_{target} ) - 1} ,$$
where FER_{target} is a target quality as a target frame error rate.

11. A network infrastructure in a radio system using a transmission power control, wherein at least one user terminal and the network infrastructure are configured to communicate using a connection over a radio interface,
wherein the at least one user terminal receiving packets during communication is configured to transmit a request of retransmission of at least one packet having failure in reception, and
wherein the network infrastructure transmitting the packets is configured to retransmit at least one packet requested as a response to the request, wherein the network infrastructure comprises:
an estimator configured to estimate quality of at least one packet having failure in reception; and
a controller configured to control transmission power of a retransmission according to the quality of the at least one packet having failure in reception.

12. The network infrastructure of claim 11, wherein the controller is configured to control the transmission power of the retransmission by adjusting a retransmission target Signal Interference Ratio (SIR) according to the quality of the at least one packet having failure in reception if the quality is worse than a target quality.

13. The network infrastructure of claim 11, wherein the controller is configured to control the transmission power of a retransmission by setting a retransmission target Signal Interference Ratio (SIR) at a minimum value if the quality is better than a target quality.

14. The network infrastructure of claim 13, wherein the controller is configured to control the transmission power of the retransmission according to an effect of the quality of the at least one packet having failure in reception on the retransmission target Signal Interference Ratio (SIR), and
wherein the controller is configured to adapt the effect according to at least one of success and failure in reception.

15. The network infrastructure of claim 14, wherein the controller is configured to weaken the effect of the quality of the at least one packet having failure in reception on the retransmission target Signal Interference Ratio (SIR) if the retransmission succeeds.

16. The network infrastructure of claim 14, wherein the controller is configured to strengthen the effect of the quality of the at least one packet having failure in reception on the retransmission target Signal Interference Ratio (SIR) if a last retransmission has a failure in reception.

17. The network infrastructure of claim 11, wherein the estimator is configured to estimate the quality of the at least one packet having failure in reception as follows:
$${FER}_{est}^{failure} = 1 - {\prod }_{i = 1}^{N} \frac{1}{1 + exp [ ( 1 - 2 \cdot {u}_{i} ) \cdot {λ}_{i} ]} ,$$
where the quality is estimated using frame error rate FERₑₛₜ^{failure}, Π represents multiplication of elements in a product, i is an index of the elements, N is a number of symbols, u represents hard decisions of symbols received, λ represents soft decisions of the symbols received, and exp is a natural exponential function.

18. The network infrastructure of claim 11, wherein the controller is configured to control the transmission power of the retransmission by adjusting a retransmission target Signal Interference Ratio (SIR) as follows:
$${SIR}_{rtarget , J + 1} = min \{ max \{ 10 \cdot {log}_{10} \{ [ {( \frac{{FER}_{est}^{failure}}{{FER}_{target}} )}^{\frac{1}{t}} - 1 ] \cdot {\sum }_{j = 1}^{J} {10}^{\frac{{SIR}_{rtarget , j}}{10}} \} , {SIR}_{r\_min} \} {SIR}_{r\_max} \} ,$$
where j stands for a retransmission index of a packet, J is a number of Hybrid Automatic Repeat Request (HARQ) transmissions of a packet, SIR_{rtarget,j} is a target SIR for a j^{th} retransmission, a subscript target means transmission target, SIRᵣ_{_{—}}ₘᵢₙ stands for a minimum value of a retransmission signal-to-noise ratio, SIRᵣ_{_{—}}ₘₐₓ stands for a maximum value of the retransmission signal-to-noise ratio and t is a parameter modifying an effect of the quality measured as FERₑₛₜ^{failure} to the retransmission target SIR.

19. The network infrastructure of claim 18, wherein the controller is configured to
update the parameter t as follows:
t(n+1)=max(t(n)−Δₛₗₒₚₑ_{_{—}}_{down},tₘᵢₙ), if the reception is in failure, otherwise
t(n+1)=min(t(n)+Δₛₗₒₚₑ_{_{—}}ᵤₚ,tₘₐₓ),
where n is an iteration index, tₘᵢₙ is a minimum value of the parameter, tₘₐₓ is a maximum value of the parameter, and
wherein the controller is further configured to form parameter Δₛₗₒₚₑ_{_{—}}ᵤₚ as follows:
$${Δ}_{slope\_up} = \frac{{Δ}_{slope\_down}}{( 1 / {FER}_{target} ) - 1} ,$$
where FER_{target} is a target quality as a target frame error rate.

20. A network infrastructure in a radio system using a transmission power control, wherein at least one user terminal and the network infrastructure are configured to communicate using a Code Division Multiple Access (CDMA) connection over a radio interface,
wherein the at least one user terminal receiving packets during communication is configured to transmit a request of retransmission of at least one packet having failure in reception, and
wherein the network infrastructure transmitting the packets is configured to retransmit at least one packet requested as a response to the request, wherein the network infrastructure comprises:
estimating means for estimating quality of at least one packet having failure in reception; and
controlling means for controlling transmission power of a retransmission according to the quality of the at least one packet having failure in reception.

21. A radio system using a transmission power control, wherein at least two transceivers are configured to communicate using a connection over a radio interface,
wherein at least one transceiver receiving packets during communication is configured to transmit a request of retransmission of at least one packet having failure in reception, and
wherein at least one transceiver transmitting the packets is configured to retransmit at least one packet requested as a response to the request, wherein the radio system comprises:
an estimator configured to estimate quality of at least one packet having failure in reception; and
a controller configured to control transmission power of a retransmission according to the quality of the at least one packet having failure in reception.

22. A radio system using a transmission power control, wherein at least one user terminal and a network infrastructure are configured to communicate using a connection over a radio interface,
wherein the at least one user terminal is configured to transmit a request of retransmission of at least one packet having failure in reception, and
the network infrastructure is configured to retransmit at least one packet requested as a response to the request, wherein the radio system comprises:
an estimator configured to estimate quality of at least one packet having failure in reception; and
a controller configured to control transmission power of a retransmission according to the quality of the at least one packet having failure in reception.

23. A base station in a radio system using a transmission power control, wherein at least one user terminal and a network infrastructure are configured to communicate using a connection over a radio interface,
wherein the at least one user terminal is configured to transmit a request of retransmission of at least one packet having failure in reception, and
wherein the network infrastructure is configured to retransmit the at least one packet requested as a response to the request, wherein the network infrastructure comprises:
estimating means for estimating quality of at least one packet having failure in reception; and
controlling means for controlling transmission power of a retransmission according to the quality of the at least one packet having failure in reception.

24. A radio network controller in a radio system using a transmission power control, wherein at least one user terminal and a network infrastructure are configured to communicate using a connection over a radio interface,
wherein the at least one user terminal is configured to transmit a request of retransmission of at least one packet having failure in reception, and
wherein the network infrastructure is configured to retransmit at least one packet requested as a response to the request, wherein the network infrastructure comprises:
estimating means for estimating quality of at least one packet having failure in reception; and
controlling means for controlling transmission power of a retransmission according to the quality of the at least one packet having failure in reception.

25. A computer program product encoding a computer process for controlling transmission power in a radio, wherein
the computer program product is embodied on a computer readable medium,
at least one user terminal and a network infrastructure are configured to communicate using a connection over a radio interface,
the at least one user terminal is configured to transmit a request of retransmission of at least one packet having failure in reception, and
the network infrastructure is configured to retransmit at least one packet requested as a response to the request, wherein the computer program product controls a computer to execute the process comprising:
estimating quality of at least one packet having failure in reception; and
controlling transmission power of a retransmission according to the quality of the at least one packet having failure in reception.

26. The computer program product of claim 25, wherein the process further comprises:
controlling the transmission power of the retransmission by adjusting a retransmission target Signal Interference Ratio (SIR) according to the quality of the at least one packet having failure in reception if the quality is worse than a target quality.

27. The computer program product of claim 26, wherein the process further comprises:
controlling the transmission power of the retransmission by setting the retransmission target Signal Interference Ratio (SIR) at a minimum value if the quality is better than a target quality.

28. The computer program product of claim 26, wherein the process further comprises:
controlling the transmission power of the retransmission according to an effect of the quality of the at least one packet having failure in reception on the retransmission target Signal Interference Ratio (SIR), and
adapting the effect according to at least one of success and failure in the reception.

29. The computer program product of claim 28, wherein the process further comprises:
weakening the effect of the quality on the retransmission target Signal Interference Ratio (SIR) if the retransmission succeeds.

30. The computer program product of claim 28, wherein the process further comprises:
strengthening the effect of the quality on the retransmission target Signal Interference Ratio (SIR) if a last retransmission has a failure in reception.

31. The computer program product of claim 25, wherein the process further comprises:
estimating the quality of the at least one packet having failure in reception as follows:
$${FER}_{est}^{failure} = 1 - {\prod }_{i = 1}^{N} \frac{1}{1 + exp [ ( 1 - 2 \cdot {u}_{i} ) \cdot {λ}_{i} ]} ,$$
where the quality is estimated using frame error rate FERₑₛₜ^{failure}, Π represents multiplication of elements in a product, i is an index of the elements, N is a number of symbols, u represents hard decisions of symbols received, λ represents soft decisions of the symbols received, and exp is a natural exponential function.

32. The computer program product of claim 25, wherein the process further comprises:
controlling the transmission power of the retransmission by adjusting a retransmission target Signal Interference Ratio (SIR) as follows:
$${SIR}_{rtarget , J + 1} = min \{ max \{ 10 \cdot {log}_{10} \{ [ {( \frac{{FER}_{est}^{failure}}{{FER}_{target}} )}^{\frac{1}{t}} - 1 ] \cdot {\sum }_{j = 1}^{J} {10}^{\frac{{SIR}_{rtarget , j}}{10}} \} , {SIR}_{ r\_min} \} {SIR}_{ r\_max} \} ,$$
where j stands for a retransmission index of a packet, J is a number of Hybrid Automatic Repeat Request (HARQ) transmissions of a packet, SIR_{r-target,j} is a target SIR for a j^{th} retransmission, a subscript target means transmission target, SIRᵣ_{_{—}}ₘᵢₙ stands for a minimum value of a retransmission signal-to-noise ratio, SIRᵣ_{_{—}}ₘₐₓ stands for a maximum value of the retransmission signal-to-noise ratio, and t is a parameter modifying an effect of the quality measured as FERₑₛₜ^{failure} on the retransmission target SIR.

33. The computer program product of claim 32, wherein the process further comprises:
updating the parameter t as follows:
t(n+1)=max(t(n)−Δₛₗₒₚₑ_{_{—}}_{down},tₘᵢₙ), if the reception is in failure, otherwise
t(n+1)=min(t(n)+Δₛₗₒₚₑ_{_{—}}ᵤₚ,tₘₐₓ),
where n is an iteration index, tₘᵢₙ is a minimum value of the parameter, tₘₐₓ is a maximum value of the parameter; and
forming parameter Δₛₗₒₚₑ_{_{—}}ᵤₚ as follows:
$${Δ}_{slope\_up} = \frac{{Δ}_{slope\_down}}{( 1 / {FER}_{target} ) - 1} ,$$
where FER_{target} is a target quality as a target frame error rate.
